(19) United States
(12) Patent Application Publication
(10) Pub. No.: US 2024/0209243 A1
(43) Pub. Date: Jun. 27, 2024

(54) TWO-PART CURABLE COMPOSITION

(71) Applicants: Thanikaivelan Veeraraghavan, Newburgh, IN (US); Karthikeyan Sengotaiyan, Newburgh, IN (US); Karthikeyan Sengotaiyan, Newburgh, IN (US); Uniseal, Inc., Evansville, IN (US)

(72) Inventors: Thanikaivelan Tindivanam Veeraraghavan, Newburgh, IN (US); Senthilkumar Veeraraghavan, Newburgh, IN (US); Karthikeyan Sengotaiyan, Newburgh, IN (US)

(21) Appl. No.: 18/286,263

(22) PCT Filed: Jun. 7, 2021
(86) PCT No.: PCT/US21/36130

§ 371 Date: Oct. 10, 2023

Related U.S. Application Data
(60) Provisional application No. 63/185,077, filed on May 6, 2021.

(51) Int. Cl. C09J 11/04; C09J 147/00; C09K 5/14

(52) U.S. Cl. CPC C09J 11/04; C09J 147/00; C09K 5/14

(57) ABSTRACT

A two-part curable composition which cures to form a thermally conductive cured product, including: a first-part having: (1) a maleic anhydride adducted polybutadiene component; (2) a non-reactive diluent component; (3) a wetting agent component; and (4) a filler component; and a second-part having: (1) a hydroxyl terminated polybutadiene component; (2) a catalytic component for catalyzing the cure reaction; (3) a diluent component; (4) a filler component; and (5) a wetting agent component, wherein at least one of the filler components of the first-part and the second-part comprises a thermally conductive filler. The compositions of the present invention are useful for bonding heat generating components, such as, for example, automotive electrical battery pack components, high-capacity batteries and electric motors in electric and hybrid vehicles.

### CROSS-REFERENCE TO RELATED APPLICATIONS

This application claims the benefit of U.S. Provisional Application Ser. No. 63/185,077, entitled “HYDROXYL TERMINATED POLYBUTADIENE WITH ANHYDRIDE CURED ELASTOMERIC POLYESTER FOR USE IN A PLURALITY OF THERMALLY CONDUCTIVE APPLICATIONS” filed May 6, 2021, which is hereby incorporated herein by reference in its entirety, including all references cited therein.

### BACKGROUND OF THE INVENTION

### 1. Field of the Invention

Thermal Interface Materials (TIMs) are used in various industries and applications based on their ability to carry heat away from key components. The dissipation of heat often creates a bottleneck for the performance of electronic devices, heat exchangers, and solar panels. The present invention relates to thermal interface elastomeric materials comprising particles of, for example, aluminum oxide, silicon nitride, aluminum nitride, boron nitride, graphite and carbon nanotubes, which are useful for heat dissipation components in electric vehicles. Enhancing the thermal conductivity and minimizing the environmental impact of these products through the selection of materials and polymers is critical to the success of these applications.

There are numerous applications where thermal management is needed, such as aerospace, automotive, electronics, mechatronics, and photonics. Thermal interface materials are employed for functional sheets, integrated circuit (IC) packaging, heat sinks, electrical power appliances, tapes, thermal gap pads, thermal gap fillers, encapsulation compounds, adhesives, grease, sealing materials, coatings, sulfur hexafluoride (SF₆) gas circuit breakers, solar panels.

### 2. Background Art

Thermal management is critical in every aspect of the electronics space, such as battery packs, integrated circuits (IC), light-emitting diodes (LED), power electronics, displays, and photovoltaics. These materials prevent degradation of the components and protect them from performance degradation or premature failure.

The thermal properties of materials have recently attracted considerable attention, which is driven by the need for effective heat removal in systems such as, automotive battery packs and power electronics. The continuing miniaturization of micro-electronic devices is setting higher requirements for reliability, performance and processing techniques for advanced automotive applications. These advanced materials are required to possess the functionally desired physical and mechanical properties, including sufficient thermal insulation, lightweight, and easily processed. Polymers have been mainly used as encapsulates and carriers in integrated electronic battery packs because of their excellent material characteristics.

Advances in the electronics industry have made thermal management an increasingly important consideration, particularly with respect to packaging issues. For instance, heat build-up in electronic products leads to reduced reliability (“mean-time-to-failure”), slower performance, and reduced power-handling capabilities. In addition, continued interest in increasing the number of electronic components on, and reducing the size of semiconductor chips, notwithstanding the desire generally to reduce power consumption thereof also contributes to the importance of thermal management. Furthermore, chip-on-board technology, where semiconductor chips are mounted directly to printed circuit boards (PCB), creates further demands for thermal management because of the more efficient use of surface area thereon (e.g., greater real estate density on the PCB).

In prior art electronic equipment, heat-dissipating members, typically heat sinks in the form of metal plates of aluminum or copper having a high heat conductivity, are used for suppressing a temperature rise of heat-generating components during operation. The heat-dissipating member conducts the heat generated by the components and releases the heat from the member surface by virtue of a temperature difference from the ambient air. For efficient conduction of the heat generated by the components to the heat-dissipating member, it is effective to fill a small gap between the component and the member with a heat conductive material. The heat conductive materials used include heat conductive adhesives and heat conductive grease laden with heat conductive fillers. Such a heat conductive material is interposed between the heat-generating component and the heat-dissipating member, thereby establishing a direct path for heat conduction from the heat-generating component to the heat-dissipating member—via the heat conductive adhesive material.

For thermally conductive applications, material has not heretofore been formulated with polybutadiene-based chemistry. Epoxy, polyurethane (PU), silicone, and thermoplastic type thermally conductive adhesives are well known in the art.

The disadvantage of epoxy chemistry is due to the exothermic reaction which causes high risk application on the battery module components and high crosslinking of cured material leads to high modulus with more stress on bonded components. The hard thermoset material is not easily repairable on bonded components.

Disadvantages of conventional PU systems are the toxic nature of isocyanate curing, poor hydrolytic and environmental stability—along with high cost.

Liquid polybutadiene resins (LPBDs) have demonstrated considerable applicability in the electrical and thermal insulation industry. These liquid polybutadiene resins can be chemically modified with hydroxyl or carboxyl functionality. LPBDs provide the added benefits of long-term storage stability, no exothermic reaction in curing, and lower formulation cost to achieve specific thermal properties in the finished product.

Polybutadiene based thermally conductive adhesive compounds are designed with excellent flexibility in a wide temperature range, as well as with customizable viscosity and cure rates.

The polybutadiene based thermally conductive materials cure at room temperature and turn into soft materials which can easily be removed from bonded substrate for rework and field repair situations.

More flexibility is desired for a thermal management element of electronic devices, polybutadiene based cured flexible material reduces internal stress in the electric device.

Stress controllability in thermal conductivity is important for electric devices. Due to the strength-elasticity trade-off, comprehensive investigation of stress-controllable conduction in high-modulus polymers is challenging.

Due to the low modulus of a polybutadiene backbone, the interconnected network favors a high stress-sensitive thermal conductivity. This dispensable thermal conductive adhesive can be an important candidate material for optimization based on stress-controllable thermal conductivity.

The polybutadiene based polyester rubber compositions of the present invention can also be prepared by simply reacting maleic anhydride adducted polybutadiene rubber and hydroxyl terminated polybutadiene rubber to form the polyester in presence of a catalyst. This can be accomplished by simply mixing the maleic anhydride terminated polybutadiene rubber blend and hydroxyl terminated poly ether polyol/polyester polyol/polybutadiene. The anhydride groups in the maleic anhydride react with hydroxyl groups present in the hydroxyl terminated polybutadiene/polyol. This reaction causes polyester chains to be grafted into the backbone of the polybutadiene rubber.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a two-part curable composition which cures to form a thermally conductive cured product, comprising, consisting essentially of, and/or consisting of: (a) a first-part comprising: (1) a maleic anhydride adducted polybutadiene component; (2) a non-reactive diluent component; (3) a wetting agent component; and (4) a filler component; and (b) a second-part comprising: (1) a hydroxyl terminated polybutadiene component; (2) a catalytic component for catalyzing the cure reaction; (3) a diluent component; (4) a filler component; and (5) a wetting agent component, wherein at least one of the filler components of the first-part and the second-part comprises a thermally conductive filler. The compositions are useful for bonding heat generating components, such as, for example, automotive electrical battery pack components, high-capacity batteries and electric motors in electric and hybrid vehicles.

In a preferred embodiment of the present invention, the weight ratio of the first-part to the second-part is approximately 1:1 by weight.

In another preferred embodiment of the present invention, the composition cures in less than approximately 60 minutes, and more preferably in less than approximately 10 minutes, from the time the first-part and the second-part are brought together at room temperature.

In yet another preferred embodiment of the present invention, the curable composition cures to form a cured product with a thermal conductivity ranging from approximately 2.0 to approximately 5.0 watts per meter-kelvin.

In one aspect of the present invention, the maleic anhydride adducted polybutadiene component of the first-part is present from approximately 10 percent to approximately 20 percent by weight of the total weight of the first-part.

In a preferred embodiment of the present invention, the hydroxyl terminated polybutadiene component of the second-part is present from approximately 10 percent to approximately 20 percent by weight of the total weight of the second-part.

In another preferred embodiment of the present invention, the thermally conductive filler is present from approximately 40 percent to approximately 80 percent by weight of the total weight of the first-part, the second-part and/or the first- and second-parts.

In yet another preferred embodiment of the present invention, the wetting agent component of the first-part is present from approximately 0.1 percent to approximately 5.0 percent by weight of the total weight of the first-part.

In one aspect of the present invention, the non-reactive diluent component of the first-part is present from approximately 5 percent to approximately 20 percent by weight of the total weight of the first-part and the second-part.

In a preferred embodiment of the present invention, the non-reactive diluent component of the first-part comprises at least one of an isopropylated triphenyl phosphate, a butylated triphenyl phosphate, an isopropylated triaryl phosphate, a tris-chloropropyl phosphate, and combinations, mixtures, and/or derivatives thereof.

In another preferred embodiment of the present invention, the catalytic component of the second-part is present from approximately 0.1 to approximately 5 per hundred resin by weight of the total weight of the second-part.

In yet another preferred embodiment of the present invention, the first-part and second-part comprise a pre-cured viscosity of approximately 200 to approximately 500 pascal-second.

In one preferred embodiment of the present invention, the average particle size of the thermally conductive filler ranges from approximately 10 to approximately 500 micrometers.

In a preferred embodiment of the present invention, the two-part curable composition includes a curable resin and a filler, wherein the filler comprises thermally conductive, smooth, spherical particles having an average diameter of less than approximately 500 microns.

In another preferred embodiment of the present invention, the thermally conductive filler comprises at least one an inorganic filler, a boron nitride, an aluminum oxide, an aluminum nitride, graphite, a silicon carbide, a carbon nanotube, a graphene nanoplatelet, and combinations, mixtures, and/or derivatives thereof.

The present invention is also directed to a two-part curable composition which cures to form a thermally conductive cured product, comprising, consisting essentially of, and/or consisting of: (a) a first-part comprising: (1) at least one maleinized polybutadiene component; (2) a non-reactive diluent component; (3) one or more wetting agent components and; (4) a filler component; and (b) a second part comprising: (1) at least one hydroxyl terminated polybutadiene or hydroxyl terminated polybutadiene, polyester polyol, polyether polyol, component; (2) a catalytic component for catalyzing the cure reaction; (3) a diluent component; and (4) a filler component, for the bonding of a heat generating component to a substrate, wherein at least one part of the composition has a filler component that comprises a thermally conductive filler.

The present invention is further directed to a two-part curable composition, comprising: an inorganic filler wherein its thermal conductivity is 20 W/m·K or more. The composition may comprise an additional inorganic filler, and the total filler content is preferably above 70 percent by volume or more based on the volume of the composition.

The present invention is likewise directed to a two-part curable composition, comprising: a thermal conductivity of 2-3 W/m·K or more, wherein an adhesive is formed from a composition comprising a maleic anhydride adducted polybutadiene component, a thermal conductive filler, diluents and a wetting agent in the first-part and a hydroxyl terminated polybutadiene component, a thermal conductive filler, diluents, a wetting agent and an amine catalyst in the second-part.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a cross-sectional schematic representation of a substrate assembly associated with a thermally conductive cured product in accordance with the present invention;

FIG. 2 of the drawings is a two-dimensional plot showing the thermal conductivity of a plurality of filler materials;

FIG. 3 of the drawings is a two-dimensional plot showing viscosity as a function of temperature;

FIG. 4 of the drawings is a two-dimensional plot showing thermal conductivity as a function of time;

FIG. 5 of the drawings is a two-dimensional plot showing thermal conductivity as a function of time;

FIG. 6 of the drawings is a two-dimensional plot showing thermal conductivity as a function of pressure;

FIG. 7 of the drawings is a two-dimensional plot showing thermal conductivity as a function of temperature; and

FIG. 8 of the drawings is a two-dimensional plot showing gel time as a function of temperature.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

As will be discussed and shown experimentally hereinbelow, the present invention is directed to unique, two-part curable compositions which cure to form thermally conductive cured products. The compositions of the present invention are useful for bonding heat generating components, such as, for example, automotive electrical battery pack components, high-capacity batteries and electric motors in electric and hybrid vehicles.

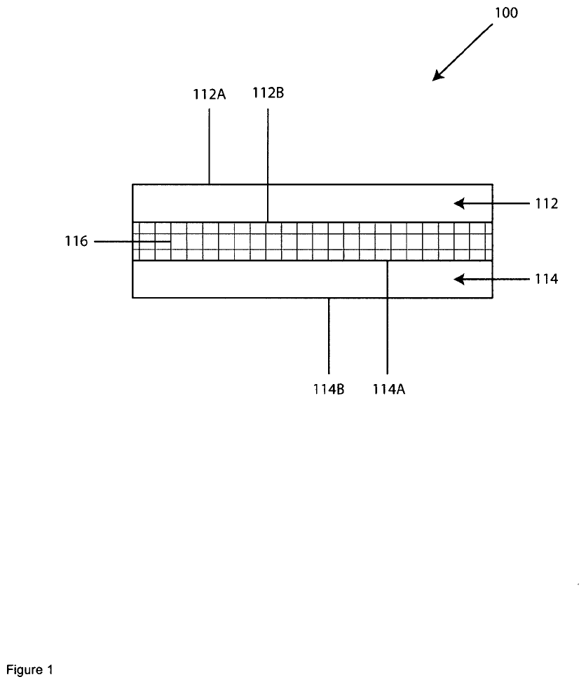

Referring now to the drawings and to FIG. 1 in particular, component assembly 100 is shown, which generally comprises first substrate 112 having first surface 112A and second surface 112B, second substrate 114 having first surface 114A and second surface 114B, and thermally conductive cured product 116. It will be understood that component assembly 100 may comprise, for illustrative purposes only, a heat sink, electrical component, a sub-assembly or part of an automotive electrical battery pack, high-capacity battery and/or an electric motor in an electric and/or hybrid vehicle. Indeed, the thermally conductive cured products of the present invention are suitable for a plurality of applications.

First substrate 112 may be fabricated from any one of a number of materials, such as, for example, steel, steel electrogalvanized with zinc, steel hot dipped galvanized with zinc, aluminum, metal alloys, d-block metals, and combinations thereof. First substrate 112 may also be fabricated from, for example, borosilicate glass, soda lime glass, float glass, natural and synthetic polymeric resins, plastics, and/or composites including Topas®, which is commercially available from Ticona of Summit, New Jersey. First substrate 112 is preferably fabricated from a sheet having a thickness ranging from approximately 0.25 mm to approximately 5.00 mm, and more preferably ranging from approximately 0.75 mm to approximately 2.50 mm. Of course, the thickness of the substrate will depend largely upon the particular application of the assembly. While particular substrate materials have been disclosed, for illustrative purposes only, it will be understood that numerous other substrate materials are likewise contemplated for use—so long as the materials exhibit appropriate physical properties, such as strength, to be able to operate effectively in conditions of intended use. Indeed, substrate assemblies in accordance with the present invention can be, during normal operation, exposed to extreme temperature variation, as well as substantial UV radiation, emanating primarily from the sun.

Second substrate 114 may be fabricated from similar and/or dissimilar materials as that of first substrate 112. As such, second substrate 114 may comprise polymers, metals, glass, and ceramics—to name a few. Second substrate 114 is preferably fabricated from a sheet having a thickness ranging from approximately 0.25 mm to approximately 5.00 mm, and more preferably ranging from approximately 0.75 mm to approximately 2.50 mm.

As will be discussed herein below, thermally conductive cured product 116 is preferably formed from a two-part curable composition comprising: (a) a first-part comprising: (1) a maleic anhydride adducted polybutadiene component; (2) a non-reactive diluent component; (3) a wetting agent component; and (4) a filler component; and (b) a second-part comprising: (1) a hydroxyl terminated polybutadiene component; (2) a catalytic component for catalyzing the cure reaction; (3) a diluent component; (4) a filler component; and (5) a wetting agent component, wherein at least one of the filler components of the first-part and the second-part comprises a thermally conductive filler.

Components of the two-part curable composition of the present invention are provided below.

### Base Polymers

Polybutadiene based polyester compounds are used in electrical encapsulation and potting formulations to provide excellent hydrophobicity, low temperature ductility, retention of properties during thermal cycling and low embedment stress properties—through a combination of ease of handling, superior electrical insulating properties, no curing exotherm, excellent low temperature ductility and stability in hot, humid environments.

Non-limiting examples of polybutadiene resins for use in accordance with the present invention include, for example, commercially available maleic anhydride functionalized polybutadiene resins with low molecular weight, 1,4-cis liquid polybutadiene adducted with maleic anhydride, which has succinic anhydride groups randomly distributed along the polymer chains which has the following characteristics; molecular weight of 3,200 Daltons (d), viscosity 61,000 centipoise (cps), and an acid number of 130. Other maleic anhydride functionalized adducts differing in maleic anhydride content and viscosity may are suitable for use in the present invention, especially those with the following characteristics; molecular weight of 3,000 Daltons, viscosity 6,000 cps, and an acid number between 70 and 90.

Maleic anhydride adducted polybutadiene having a molecular weight of 5,000 Daltons, viscosity of 36,000-60,000 cps, and an acid number between 54.6 and 60.6 is suitable for use in accordance with the present invention, as well as, maleinized polybutadiene having a molecular weight of approximately 5,200 Daltons, viscosity 25,000-50,000 cps, and an acid number between 49 and 59.

Copolymer type maleinized polybutadiene having a molecular weight of approximately 9,900 Daltons, viscosity of 75,000 cps±1,500 cps, and an acid number between 28.5 and 40.0 (molar % of 1-2 vinyl Butadiene—20-40%, styrene, % by wt. 17-27%) is suitable for use in accordance with the present invention.

Hydroxyl terminated polybutadiene polymer prepared by radical polymerization are suitable for use in accordance with the present invention, and commercially available, contain large percentage of oligomers and polymers with branched microstructures and more than 2.0 hydroxyl functionalities per molecules with average functionality of such molecules 2.4 to 2.6 hydroxyl group per polymer molecule. Hydroxyl terminated polybutadiene resins having number average molecular weights, “Mₙ” of 2,800 Daltons, OH group per chain 2.5, viscosity approximately 4,000 cps, molecular weight of 1,200 Daltons, OH Group per chain—2.5, TG—70° C., viscosity of 1,200 cps±200 cps. Hydroxyl terminated liquid polyisoprene are also suitable for use in accordance with the present invention and preferably have the following characteristics molecular weight of 4,700 Daltons, OH Group per chain of 2.5, and viscosity of 50,000 cps±10,000 cps.

In accordance with the present invention, suitable non-branched hydroxyl-terminated polybutadienes are low molecular weight resins, preferably having an average molecular weight of about 1,000 to 20,000 Daltons, more preferably about 2,000 to 10,000 Daltons, and a 1,2-vinyl content of about 15-90 mole percent, preferably 20 to 70 mole percent, with an average hydroxyl functionality less than or equal to 2 per molecule. These non-branched polybutadienes are preferably derived from anionic polymerization. The hydroxyl groups can be primary or secondary. Suitable branched hydroxyl-terminated polybutadienes are also low molecular weight resins, with a preferred average molecular weight of about 1,000 to 20,000 Daltons, more preferably about 2,000 to 10,000 Daltons, and have a 1,2-vinyl content of about 15-90 mole percent, preferably 20 to 70 mole percent, and an average hydroxyl functionality of more than 2.0, preferably about 2.4-2.6 per molecule. These branched polybutadienes are preferably derived from radical polymerization.

In accordance with the present invention, suitable dimerized polyol provide polyester and polyurethane coatings with a range of favorable features, such as flexibility and hydrolytic resistance. Other coating systems could benefit from the introduction of dimer acids as well. Conversion of dimerized fatty acid to the corresponding diol, or by building dimerized fatty acid into the hydroxyl-terminated polyesters, makes it suitable for incorporation in polyurethanes and esterification reactions. The dimer fatty acid-based polyester polyols can be semi-crystalline or amorphous type, depending on the choice of polyol monomer. Suitable dimerized polyester polyols are low molecular weight resins, with a preferred average molecular weight of about 500-10,000 Daltons, more preferably 1,000-5,000 Daltons, yet more preferably about 2,000 Daltons, a viscosity of about 22,000 to 30,000 cps, an OH Value of approximately 52-60. The dimerized polyester polyol of the present invention preferably includes a hydroxyl functionality of approximately 2.4.

Polyols of the present invention are preferably used for flexible applications from raw materials containing a fewer number of hydroxyl groups (functional groups). Dipropylene glycol has two hydroxyl groups, glycerin has three, and sorbitol/water solution shows functionality of 2.75. Polyols for rigid applications use raw materials containing higher number of hydroxyl groups (functional groups). Sucrose shows a functionality of eight, sorbitol has a functionality of six, toluene diamine has a functionality of four, and Mannich bases show a functionality of four. Propylene oxide and/or ethylene oxide is added to the initiators to achieve the desired molecular weight. The order of addition and the amounts of each oxide affect many polyol properties, viz., compatibility, water solubility, and reactivity. Polyols containing only propylene oxide are terminated with secondary hydroxyl groups and are less reactive than polyols capped with ethylene oxide, which have primary hydroxyl groups. Suitable polyol propylene oxides preferably include a molecular weight of 2,000 Daltons, a viscosity of 250-500 cps, and an OH value of approximately 56. A special class of polyether polyol for use in the present invention is poly (tetra methylene ether) glycol, which is made by polymerizing tetrahydrofuran, is used in high-performance coating, wetting, and elastomer applications.

Another object of the present invention is to provide a thermosetting unsaturated polyester resinous composition containing a suitable copolymer polybutadiene polymer wherein the thus prepared composition has a liquid state before it is cured, but after curing the composition, the resulting cured material has excellent elasticity and elongation properties, good thermal and electrical properties, good water-proofing properties, a high resistance to the occurrence of cracks, and good chemical resistance. A still further object of the present invention is to provide a polyester resin composition useful in electrical and thermal insulation, casting and molding, adhesives, paints and the like.

Provided below are non-limiting examples of structural formulas for maleinized polybutadiene, hydroxyl terminated polybutadiene, and polyol respectively:

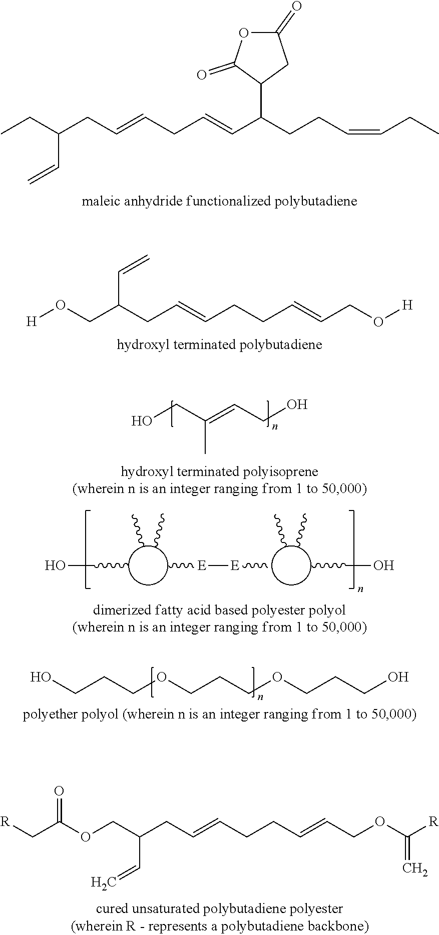

### Catalysts

Amine catalysts are preferably used in accordance with the present invention to control and/or balance the gelling reaction. Several organometallic compounds or salts may be used as catalysts in the production of the esterification reaction. Amine catalysts are typically 0.1 to 5.0 per hundred resin (phr) of the formulation.

Tris-(dimethylaminomethyl) phenol also acts as a curing agent. It is a Lewis Base catalyst for curing liquid epoxy resins especially for those cured with polycarboxylic acids and as well as for the hydroxyl and anhydride reaction, polyol and isocyanate trimerization reactions. Also, it is used as an activator for other curing agents including amid amines, amine adducts and polyamides in coatings, flooring and concrete applications. It is a multi-purpose curative that finds use in a variety of systems.

Provided below are non-limiting examples of structural formulas for catalyst of the present invention:

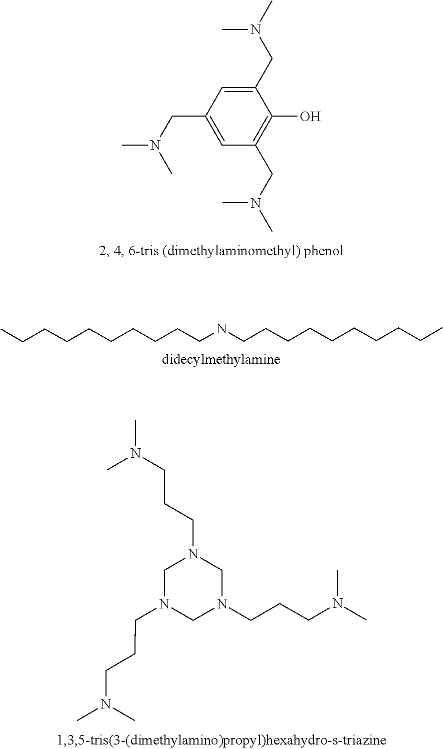

### Thermally Conductive Fillers

In general, thermal conductivity increases with increased conductive filler content. Adhesives undergo a percolation transition where the thermal conductivity of the composite rapidly increases by several orders of magnitude and its nature changes from an insulator to a conductor. This behavior is attributed to the formation of a thermally conductive network throughout the insulating matrix material when the filler content is at or above the percolation threshold.

The present invention provides a thermal conductive composition including a base polymer material arranged to form a matrix and mixed with conductive particulate fillers. To form a conductive network, a conduction promoter is arranged to saturate a filler surface of the base material that is filled with conductive particulate fillers, where the conduction promoter is an immiscible wetting agent with an ultra-low particle filler volume fraction. A mixture of the base polymer material, conductive particulate fillers, and the immiscible wetting agent form a particle-filled polymeric suspension that undergoes capillary forces exerted by the immiscible wetting agent. Due to the capillary forces, capillary bridges are arranged between the conductive particulate fillers. Percolation of the particle-filled polymeric suspension and the presence of capillary bridges form a highly conductive network, enhancing the thermal conductivity of the adhesive.

A wide range of different thermally conductive fillers may be used in exemplary embodiments of a thermal interface material according to the present disclosure. In preferred embodiments, the thermally conductive fillers have a thermal conductivity of at least 1.5 W/m·K (Watts per meter Kelvin) or more. Suitable thermally conductive fillers include, for example, zinc oxide, boron nitride, aluminum oxide, aluminum nitride, graphite, ceramics, and combinations thereof (e.g., aluminum oxide and zinc oxide, etc.). In addition, exemplary embodiments of a thermal interface material may also include different grades (e.g., different sizes, different purities, different shapes, etc.) of the same (or different) thermally conductive fillers. By varying the types and grades of thermally conductive fillers, the final characteristics of the thermal interface material (e.g., thermal conductivity, viscosity, gel time, cost, hardness, etc.) may be varied as desired.

The particle size of the inorganic filler is preferably 30 micrometers or more, more preferably 100 micrometers or more. Further preferably, the particle size of the inorganic filler is 200 micrometers or more, and the most preferably 300 micrometers or more. Larger particle size of an inorganic filler increases thermal conductivity of the cured thermoset comprising the inorganic filler. However, the particle size of the inorganic filler is preferably less than 400 micrometers. Particle size is defined herein as median size (D50). When assessing particle size of inorganic fillers, agglomerated size is assessed as the particle size if the inorganic fillers are permanently or semi-permanently agglomerated.

Aluminum oxide fillers are the most cost-effective heat conductive materials. They are easy-to-use and designed to improve the co-existence of filler and matrix in thermally sensitive environments. They allow the high loadings necessary to transfer heat away from the electronic part, and the resulting part has exceptional properties appropriate for thermal management of polymeric and resin compounds. In order to achieve high loads, fillers must be compatible/adherent with the polymer matrix, and the final product should possess high mechanical strength. Aluminum oxide features specific particle shapes, fitted particle size distributions and optimized functional surface characteristics which are designed especially for electronic applications. The improved dispersibility of aluminum oxide results in lower viscosities at high filler contents. Numerous applications also require the combination of electrical and thermal insulation. On account of its appropriate dielectric properties, in many cases aluminum oxide is the filler of choice for electrically or thermal insulating polymers. It is of specific interest because of its ability to decrease the coefficient of thermal expansion to limit shrinkage, improve heat distortion temperature, and impart high mechanical strength.

Aluminum nitride (AlN) has a highly covalent bonded wurtzite structure with a high thermal conductivity and a low thermal expansion coefficient (CTE) of 4.5 ppm/° C. that matches well with silicon devices. Typical thermal conductivity of AlN is 140-180 W/m·K., but varies in the range 18-285 W/m·K. in polycrystalline AlN ceramics depending on the process condition, purity of starting materials, and microstructures. Silicon carbide (SiC) ceramics have drawn a lot of interest as a high thermal conductivity dielectric material used in insulated metal substrate (IMS) for power electronic circuit modules. SiC have several benefits: high mechanical properties (flexural strength >800 MPa, Vickers' hardness >10 GPa), high electrical resistivity, and excellent thermal properties with thermal resistance, high thermal conductivity 70-150 W/m·K. However, in reality, fabrication of SiC with high thermal conductivity and high mechanical strength is not easy due to difficulties in densification and morphological control in microstructures. Carbon-based fillers can also be used in thermally conductive adhesive system. To evaluate the thermal conductivity of such fillers, a liquid matrix dispersion was made using specialized dispersion equipment. The filler/matrix mixture was then cured and tested for thermal conductivity. Multi-wall carbon nanotubes, graphene-like nano platelets, and graphite were used as fillers and their effect on conductivity was investigated. Thermal conductivity was measured at different filler loads. It was found that the formation of percolation paths greatly enhanced thermal conductivity. The behavior of composites containing each single filler was compared with that of hybrid composites containing combinations of two different fillers. Results show that fillers with different aspect ratios displayed a synergetic effect resulting in a noticeable improvement of thermal conductivity.

Thermal conductivity of single carbon nano fillers are very good. In fact, the electrical conductivity of a single MWCNT ranges between 10⁵ S/m and 10⁷ S/m, while 10⁵ S/m is a typical value of conductivity for a GNP. Thermal conductivity values of 2000 W/mK and 5000 W/mK are generally accepted for a graphene nano plate and multi-wall carbon nano tube (GNP and MWCNT), respectively thermal conductivity of these Nano fillers is much better than that of graphite (298 W/mK) which, on the contrary, shows similar electrical conductivity. Additionally, very different values of thermal conductivity can also be found in the literature for MWCNTs and GNPs since their conductivity is strongly affected by the presence of defects, the production process the number of planes in the NP.

TABLE 1
(PROPERTIES OF THERMAL CONDUCTIVE FILLERS)

| Properties | | | | | | | |
|---|---|---|---|---|---|---|---|
| (Units) | Al₂O₃ | ALN | BN | SiC | GNP | Graphite | CNT |
| Thermal | 28-35 | 170-220 | 300 | 150 | 2000 | 398 | 3000 |
| Conductivity | | | | | | | |
| W/m · K | | | | | | | |
| Particle Size | 20-50 | 50-70 | 35-70 | 40-80 | <2 | 30-200 | 0.7-0.9 |
| Distribution (μm) | | | | | | | |
| Density (g/cm3) | 3.99 | 3.26 | 2.25 | 3.21 | 0.3 | 2.26 | 1.3 |
| Shape | Spherical | Needle | Hexagonal | Sharp | Flakes | Hexagonal | Fiber |
| | | | | Edged | | Crystal | |
| | | | | | | Structure | |
| BET Surface | 0.16 | 0.9 | <3.5 | 2.0 | 750 | 0.5 | 1315 |
| Area (m2/g) | | | | | | | |

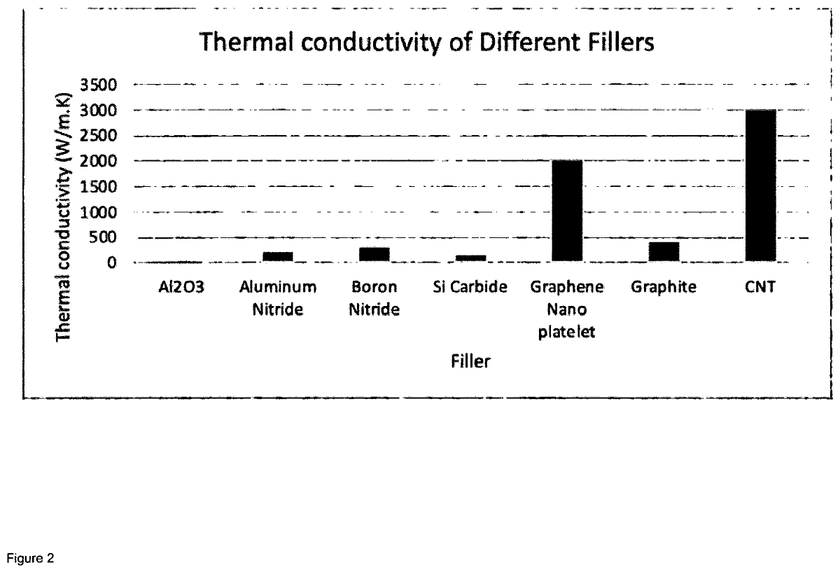

Table 1 above lists commercially available thermally conductive fillers and corresponding thermal conductive range. FIG. 2 of the drawings provides a two-dimensional plot showing the thermal conductivity for a plurality of filler materials.

### Abbreviations

Al2O3—Aluminum oxide, SiC—Silicon Carbide, GNP—Graphene Nanoplatelet, CNT—Carbon Nanotube AlN—Aluminum Nitride, BN—Boron Nitride.

### Non-Reactive Diluents/Flame Retardant Plasticizers

Non-reactive diluents/flame retardant plasticizers of the present invention are based on phosphate esters and effectively replace and avoid the use of the most flammable component (i.e., the plasticizer itself). Commonly available phosphate ester plasticizers are of three major types: triaryl phosphates, alkyl diaryl phosphates, and their mixtures. Although most phosphate ester plasticizers can be used as primary plasticizers, they are usually blended with lower cost phthalate ester plasticizers to obtain the desired performances at a minimum loading.

Flame retardancy is improved by flame retardants that cause the formation of a surface film of low thermal conductivity and/or high reflectivity that reduces the rate of heating. It is also improved by flame retardants that serve as a heat sink by being preferentially decomposed at a low temperature. It is yet further improved by flame retardant coatings that upon exposure to heat intumesce into a foamed surface layer with low thermal conductivity properties.

Phosphate ester plasticizers were among the first flame retardant additives actively used in elastomeric adhesives. Thermal and electrical insulation products were obtained using phosphate esters as plasticizers. Nowadays, phosphate ester plasticizers are used as primary flame retardants in flexible formulations. They also find use in the preparation of flexible films, sheeting, and other significant applications where flame test requirements cannot be met with the usual inorganic flame retardant products.

The flame retardants used as additives can be subdivided into nonreactive and reactive types, and the non-reactive type can be further divided into organic and inorganic additives. Although a very large number of flame retardants can be used as additives, at this time a small group of distinct chemical types dominates the field.

Commercially available non-reactive type flame retardant plasticizer for elastomeric adhesive application include isopropylated triphenyl phosphate, butylated triphenyl phosphate (BPP), isopropylated triaryl phosphate, tris(chloropropyl)phosphate (TCPP), CDP cresyl diphenyl phosphate, TCP tricresyl phosphate, RDP resorcinol bis (diphenyl phosphate) and BDP bisphenol A bis-(diphenyl phosphate). Isopropylated triphenyl phosphate ester is especially preferred because it can also serve as a viscosity reducer.

Provided below are non-limiting examples of structural formulas for non-reactive diluents/flame retardant plasticizers of the present invention:

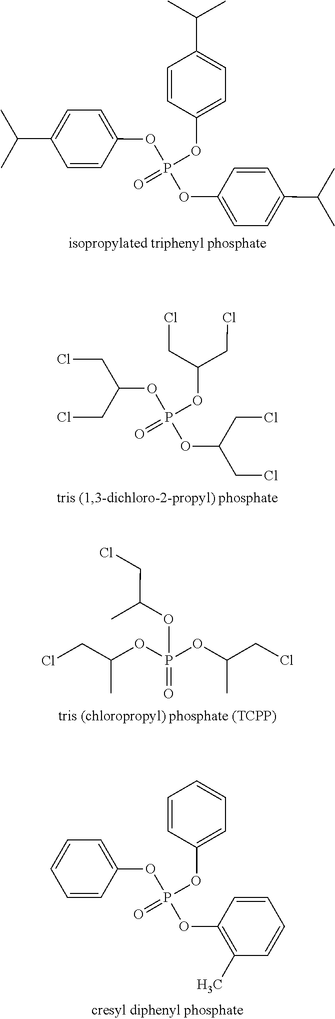 [SMILES: CC(C)c1ccc(OP(=O)(Oc2ccc(C(C)C)cc2)Oc2ccc(C(C)C)cc2)cc1 ; O=P(OC(CCl)CCl)(OC(CCl)CCl)OC(CCl)CCl ; CC(CCl)OP(=O)(OC(C)CCl)OC(C)CCl ; Cc1ccccc1OP(=O)(Oc1ccccc1)Oc1ccccc1]

### Wetting Agents/Process Additives

Wetting agents/process additives/dispersing agents of the present invention are preferably oligomers or polymers which stabilize dispersions of pigments and fillers against flocculation. Suitable wetting agents are preferably selected for polymer and filler matrix to wet out effectively. The additives improve the wetting and dispersing of all inorganic fillers. The additives provide lower viscosity and enable higher filler loading. Preferably wetting agents of the present invention include, for example, commercially available Tego Disperse 755W, 741W, 653, 670, 652, 656 and BYK Disperbyk 111, 108, 118, 199. One preferred wetting agent used in the present invention is Disperbyk 118 due to its strong viscosity reduction character.

The invention is further described by additional examples and experiments hereinbelow.

In this example, two-component dispensable thermal interface material mixture according to the present invention comprising a first-part and a second-part were prepared as follows:

The first-part of the composition was prepared using the components of Table 1.

The second-part of the composition was prepared using the components of Table 2.

### Base Blend—A1

In a separate vessel Base blend A1 mixture is formed by blending 82 parts of Maleinized polybutadiene resin (Viscosity 61000±1000 cps, Molecular weight 3200±500, Acid Number approx. 110-130, TG approx.—92° C.), 25 parts Alkylated triphenyl phosphate esters and 1 parts of wetting Agent.

### Base Blend—A2

In separate vessel Base blend A2 mixture is formed by blending 82 parts of Maleinized polybutadiene resin (Viscosity 48000±1200 cps, Molecular weight 5000±500, Acid Number approx. 55-60, TG approx.—85° C.), 25 parts Alkylated triphenyl phosphate esters and 1 parts of wetting Agent.

### Base Blend—A3

In separate vessel Base blend A3 mixture is formed by blending 82 parts of Maleinized polybutadiene resin (Viscosity 25000±5000 cps, Molecular weight 5200±500, Acid Number approx. 49-59, TG approx.—84° C.), 25 parts Alkylated triphenyl phosphate esters and 1 parts of wetting Agent.

### Base Blend—A4

In separate vessel Base blend A4 mixture is formed by blending 82 parts of Maleinized polybutadiene resin (Viscosity 25000±7000 cps, Molecular weight 3200±500, Acid Number approx. 50-60, TG approx.—87° C.), 25 parts Alkylated triphenyl phosphate esters and 1 parts of wetting Agent.

### Base Blend—A5

In separate vessel Base blend A5 mixture is formed by blending 82 parts of Maleinized polybutadiene resin (Viscosity 5000±1000 cps, Molecular weight 3000±500, Acid Number approx. 70-90, TG approx.—95° C.), 25 parts Alkylated triphenyl phosphate esters and 1 parts of wetting Agent.

### Base Blend—B1

In a separate vessel Base blend B1 mixture is formed by blending 83 Parts by weight of the Hydroxyl terminated polybutadiene (Viscosity 4000±500 cps, Molecular Weight 2800, OH group per chain 2.5, TG—75° C.), 24 parts triphenyl phosphate esters, 0.5 phr of Amine catalyst, 0.5 parts wetting Agent.

### Base Blend—B2

In a separate vessel Base blend B2 mixture is formed by blending 83 Parts by weight of the Hydroxyl terminated polybutadiene (Viscosity 2000±500 cps, Molecular Weight 1200, OH group per chain 2.5, TG—70° C.), 24 parts triphenyl phosphate esters, 0.5 phr of Amine catalyst, 0.5 parts wetting Agent.

### Base Blend—B3

In a separate vessel Base blend B3 mixture is formed by blending 83 Parts by weight of the Hydroxyl terminated polybutadiene (Viscosity 22000±500 cps, Molecular Weight 1450, OH group per chain 2.5, TG—47° C.), 24 parts triphenyl phosphate esters, 0.5 phr of Amine catalyst, 0.5 parts wetting Agent.

### Base Blend—B4

In a separate vessel Base blend B4 mixture is formed by blending 83 Parts by weight of the Dimerized polyester polyol (Viscosity 18000±500 cps, Molecular Weight 2000, OH value 52-60, TG—30° C.), 24 parts triphenyl phosphate esters, 0.5 phr of Amine catalyst, 0.5 parts wetting Agent.

### Base Blend—B5

In a separate vessel Base blend B5 mixture is formed by blending 83 Parts by weight of the propylene oxide-based Polyether polyol (Viscosity 250 cps, Molecular Weight 2000, OH group per chain 2.0, OH value 54-59), 24 parts triphenyl phosphate esters, 0.5 phr of Amine catalyst, 0.5 parts wetting Agent.

### Mixing Procedure

### Blending Base A:

Purge mixing vessel 5 min with Nitrogen, then add: Maleinized polybutadiene resin, Alkylated triphenyl phosphate esters and wetting agent then mix with Nitrogen for 10 minutes at 15 rpm then mix without Nitrogen for 20 minutes at 30 Rpm then scrape the blades and can. Then mix with Nitrogen for 2 minutes at 45 and then mix without Nitrogen for 45 minutes at 45 rpm with vacuum. Check viscosity then package.

### Record Mixing Vessel Temp, Material Temp, Lab Temp and Lab Humidity.

### Blending Base B:

Purge mixing vessel 5 min with Nitrogen, then add Hydroxyl terminated polybutadiene, Alkylated triphenyl phosphate esters, wetting Agent and Amine catalyst then mix with Nitrogen for 10 minutes at 15 rpm then mix without Nitrogen for 20 minutes at 30 Rpm then scrape the blades and can. Then mix with Nitrogen for 2 minutes at 45 and then mix without Nitrogen for 45 minutes at 45 rpm with vacuum. Check viscosity then package.

### Record Mixing Vessel Temp, Material Temp, Lab Temp and Lab Humidity.

### Experiment A Making:

Purge mixing vessel 5 min with Nitrogen, then add Base blend A and Thermal conductive fillers then mix with Nitrogen for 10 minutes at 15 rpm then mix without Nitrogen for 20 minutes at 30 rpm then scrape the blades and can. Then mix with Nitrogen for 2 minutes at 45 and then mix without Nitrogen for 60 minutes at 60 rpm with vacuum. Check viscosity if the viscosity in the range then Scrape the blades and bowl. Mix with Nitrogen for 5 minutes at 15 rpm in reverse. Then mix for 60 minutes at 15 Rpm in reverse with vacuum. Check viscosity check final viscosity. Then package.

### Record Mixing Vessel Temp, Material Temp, Lab Temp and Lab Humidity.

### Experiment B Making:

Purge mixing vessel 5 min with Nitrogen, then add Base blend B and Thermal conductive fillers then mix with Nitrogen for 10 minutes at 15 rpm then mix without Nitrogen for 20 minutes at 30 Rpm then scrape the blades and can. Then mix with Nitrogen for 2 minutes at 45 and then mix without Nitrogen for 60 minutes at 60 Rpm with vacuum. Check viscosity if the viscosity in the range then Scrape the blades and bowl. Mix with Nitrogen for 5 minutes at 15 Rpm in reverse. Then mix for 60 minutes at 15 Rpm in reverse with vacuum. Check viscosity check final viscosity then package.

### Record Mixing Vessel Temp, Material Temp, Lab Temp and Lab Humidity.

Individual Viscosity's of Experiment A's and Experiment B's measured by Plate to plate Rheometer (TA Instruments—AR 2000) (40 mm plate, 1000 micron gap, 2.4 shear rate, 23±1° C.)

Experiment A's viscosities ranges between 180-2000 Pascal second

Experiment B's viscosities ranges between 180-2000 Pascal second

After Experiment A's and Experiment B's filled into 1:1 mix ratio two component dispensing kit dispensed together which will be used for all testing. The cure chemistry of this composition is such that good green strength (Gel time) occurs between 10-60 minutes after dispensing at ambient temperature (23±1° C.). Full cure has taken place between 24-72 hours at ambient temperature. All the tests on the cured samples run after 72 hours.

Thermal conductivity in accordance with described ASTM D5470-12 Method. The thermal conductivity measured (Analysis Tech—TIM tester 1400) different test pressure, different temperature and different test sample thickness described according test tables.

TABLE 2

| | Ex | Ex | Ex | Ex | Ex | Ex | Ex | Ex | Ex | Ex | Ex | Ex | Ex | Ex | Ex | Ex |
|---|---|---|---|---|---|---|---|---|---|---|---|---|---|---|---|---|
| Mixer | 1A | 2A | 3A | 4A | 5A | 6A | 7A | 8A | 9A | 10A | 11A | 12A | 13A | 14A | 15A | 16A |
| Base | 108 | | | | | 150 | | | | | | | | | | |
| Blend A1 | | | | | | | | | | | | | | | | |
| Base | | 108 | | | | | 60 | 60 | 60 | 60 | 60 | 60 | | | | |
| Blend A2 | | | | | | | | | | | | | | | | |
| Base | | | 108 | | | | | | | | | | 108 | 108 | 108 | 108 |
| Blend A3 | | | | | | | | | | | | | | | | |
| Base | | | | 108 | | | | | | | | | | | | |
| Blend A4 | | | | | | | | | | | | | | | | |
| Base | | | | | 108 | | | | | | | | | | | |
| Blend A5 | | | | | | | | | | | | | | | | |
| Graphite 1 | | | | | | | 340 | | | | | | | | | |
| Aluminum | 292 | | | | | | | 340 | | | | | 142 | 142 | 142 | 142 |
| oxide | | | | | | | | | | | | | | | | |
| Aluminum | | 292 | | | | | | | 340 | | | | 50 | | | |
| nitride | | | | | | | | | | | | | | | | |
| Boron | | | 292 | | | | | | | 340 | | | 50 | 50 | | |
| nitride | | | | | | | | | | | | | | | | |
| SiC | | | | 292 | | | | | | | 340 | | 50 | 50 | 50 | |
| Graphite 2 | | | | | 292 | | | | | | | 340 | | 50 | 50 | 50 |
| Graphene | | | | | | | | | | | | | | | 50 | 50 |
| Nano | | | | | | | | | | | | | | | | |
| Platelet | | | | | | | | | | | | | | | | |
| Graphite 3 | | | | | | 250 | | | | | | | | | | 50 |
| CNT | | | | | | | | | | | | | | | | |
| (Carbon | | | | | | | | | | | | | | | | |
| Nano | | | | | | | | | | | | | | | | |
| tube) | | | | | | | | | | | | | | | | |

Graphite 1—Particle size (20-40 micron)
Graphite 2—Particle size (50-70 micron)
Graphite 3—Particle size (70-100 micron)

The first part of the composition was prepared using the components of Table 1

On the Exp. 1A to 5A loading level (%) of base blends A1-A5 is same, in the same way was done on the loading level (%) of different thermal conductive fillers (Aluminum oxide, ALN, BN, SiC, Graphite, GNP, CNT) This loading level (%) is considered optimum level.

On the Exp. 6A we used base blend A1 but higher than optimum loading level and lower than optimum loading level (%) of thermal conductive filler (Graphite).

On the Exp. 7A to 12A we used base blends A2 but lower than optimum loading level and higher optimum loading level (%) of different thermal conductive fillers (Aluminum oxide, ALN, BN, SiC, Graphite).

On the Exp. 13A to 16A we used base blend A3 in optimum loading level but on the filler used optimum loading level (%) but synergistic combinations of Aluminum oxide, ALN, BN, SiC, Graphite.

TABLE 3

| | Ex | Ex | Ex | Ex | Ex | Ex | Ex | Ex | Ex | Ex | Ex | Ex | Ex | Ex | Ex | Ex |
|---|---|---|---|---|---|---|---|---|---|---|---|---|---|---|---|---|
| Mixer | 1B | 2B | 3B | 4B | 5B | 6B | 7B | 8B | 9B | 10B | 11B | 12B | 13B | 14B | 15B | 16B |
| Base | 108 | | | | | 150 | | | | | | | | | | |
| Blend | | | | | | | | | | | | | | | | |
| B1 | | | | | | | | | | | | | | | | |
| Base | | 108 | | | | | 60 | 60 | 60 | 60 | 60 | 60 | | | | |
| Blend | | | | | | | | | | | | | | | | |
| B2 | | | | | | | | | | | | | | | | |
| Base | | | 108 | | | | | | | | | | 108 | 108 | 108 | 108 |
| Blend | | | | | | | | | | | | | | | | |
| B3 | | | | | | | | | | | | | | | | |
| Base | | | | 108 | | | | | | | | | | | | |
| Blend | | | | | | | | | | | | | | | | |
| B4 | | | | | | | | | | | | | | | | |
| Base | | | | | 108 | | | | | | | | | | | |
| Blend | | | | | | | | | | | | | | | | |
| B5 | | | | | | | | | | | | | | | | |
| Graphite 1 | | | | | | | 340 | | | | | | | | | |
| Aluminum | 292 | | | | | | | 340 | | | | | 142 | 142 | 142 | 142 |
| oxide | | | | | | | | | | | | | | | | |
| Aluminum | | 292 | | | | | | | 340 | | | | 50 | | | |
| nitride | | | | | | | | | | | | | | | | |
| Boron | | | 292 | | | | | | | 340 | | | 50 | 50 | | |
| nitride | | | | | | | | | | | | | | | | |
| SiC | | | | 292 | | | | | | | 340 | | 50 | 50 | 50 | |
| Graphite 2 | | | | | 292 | | | | | | | 340 | | 50 | 50 | 50 |
| Graphene | | | | | | | | | | | | | | | 50 | 50 |
| Nano | | | | | | | | | | | | | | | | |
| Platelet | | | | | | | | | | | | | | | | |
| Graphite 3 | | | | | | 250 | | | | | | | | | | 50 |
| CNT | | | | | | | | | | | | | | | | |
| (Carbon | | | | | | | | | | | | | | | | |
| Nano | | | | | | | | | | | | | | | | |
| tube) | | | | | | | | | | | | | | | | |

Graphite 1—Particle size (20-40 micron)
Graphite 2—Particle size (50-70 micron)
Graphite 3—Particle size (70-100 micron)

The second part of the composition was prepared using the components of Table 2.

On the Exp. 1B to 5B loading level (%) of base blends B1-B5 is same, in the way was done same loading level (%) of different thermal conductive fillers (Aluminum oxide, ALN, BN, SiC, Graphite) This loading level (%) is considered the optimum level.

On the Exp. 6B we used base blend B1 but higher than optimum loading level and used lower than optimum loading level (%) of thermal conductive fillers (Aluminum oxide, ALN, BN, SiC, Graphite).

On the Exp. 7B to 12B we used base blends B2 but lower than optimum loading level and used higher optimum loading level (%) of different thermal conductive fillers (Aluminum oxide, ALN, BN, SiC, Graphite).

On the Exp. 13B to 16B we used base blend B3 in optimum loading level but on the filler used optimum loading level (%) but synergistic combinations of Aluminum oxide, ALN, BN, SiC, Graphite.

### Preparing Combinations.

Exp. 1A from table 1 and Exp. 1B from table 2 are dispensed 1:1 ratio and mixed material used for the tests.

Exp. 2A from table 1 and Exp. 2B from table 2 are dispensed 1:1 ratio and mixed material used for the tests.

Exp. 3A from table 1 and Exp. 3B from table 2 are dispensed 1:1 ratio and mixed material used for the tests.

TABLE 4

| | | Gel Time | Hardness | Thermal conductivity |
|---|---|---|---|---|
| Ex. | Mix | (minutes) | (shore A) | (W/m · K) |
| 1 | A1/B1 | 25 | 62 | 3.01 |
| 2 | A2/B2 | 78 | 38 | 2.94 |
| 3 | A3/B3 | 10 | 79 | 3.0 |
| 4 | A4/B4 | 58 | 72 | 2.78 |
| 5 | A5/B5 | 71 | 45 | 2.74 |
| 6 | A6/B6 | 35 | 65 | 2.89 |
| 7 | A7/B7 | 34 | 67 | 2.87 |
| 8 | A8/B8 | 37 | 68 | 2.84 |
| 9 | A9/B9 | 45 | 48 | 2.92 |
| 10 | A10/B10 | 44 | 44 | 3.09 |
| 11 | A11/B11 | 42 | 46 | 3.17 |
| 12 | A12/B12 | 48 | 48 | 3.27 |
| 13 | A13/B13 | 47 | 49 | 2.88 |
| 14 | A14/B14 | 51 | 46 | 2.82 |
| 15 | A15/B15 | 12 | 74 | 3.11 |
| 16 | A16/B16 | 14 | 72 | 3.10 |

Maleic anhydride functional polybutadiene can react with hydroxyl functional polybutadiene to form gel structures of various hardness. Equal stoichiometry is required to ensure all available functional polyol groups are reacted to give the maximum crosslinking to ensure a tack free surface.

Another solution to increase the thermal conductivity of adhesive is adding high amounts of thermal conductive filler.

Although utilization of a single filler type can result in the previously described network, it will inevitably contain tiny voids that are difficult to fill even in a liquid polymer matrix. The introduction of additional filler types or shapes is beneficial to fill the voids and to further enhance the effective thermal conductivity of the Adhesive. There is always a preferable concentration ratio between different constituent fillers to enhance the thermal conductivity. By studying the thermal conductivity of polybutadiene-based material filled with Al2O3, ALN, BN, CNTs and Graphite, results showed that the maximum thermal conductivity could be achieved with loading weight ratio of 1:9 to 4:6 between the filler and resin ratio, ideal ratio is 1.5:8.5, and this maximum thermal conductivity is higher than that of the adhesive with variations of adhesive and any single conductive filler.

### Temperature Vs Viscosity

Viscosity varies with temperature. Following is a chart of the viscosity of each component at different temperatures—as you can see the viscosity decreases (becomes “runnier”) with higher temperature. In practical terms, an adhesive that has been kept at Low temperature (0-15° C.) may be difficult to dispense but once it has warmed up to normal room temperature (around 20-30° C.) it can be more easily dispensed.

Viscosity was measured by TA Instruments—AR 2000 (Plate-to-plate Rheometer: 40 mm plate, 1,000 micron gap, 2.4 shear rate)

TABLE 5

| | Temperature ± | Viscosity (Pa · s) | | | | | |
|---|---|---|---|---|---|---|---|
| S. No | 1° C. | Part A1 | Part B1 | Part A2 | Part B2 | Part A3 | Part B3 |
| 1 | 10 | 1300.2 | 851.2 | 1240 | 848 | 1322 | 844 |
| 2 | 20 | 388.9 | 288.3 | 362.6 | 279.5 | 396 | 271.3 |
| 3 | 30 | 250.2 | 193 | 233.8 | 192.4 | 264 | 185 |
| 4 | 40 | 119.8 | 115.7 | 107.4 | 114.4 | 124 | 110.3 |
| 5 | 50 | 69.15 | 86.41 | 65.5 | 85.6 | 71.5 | 82.5 |
| 6 | 60 | 40.54 | 66.49 | 38.6 | 65.8 | 43.4 | 61.3 |
| 7 | 70 | 28.23 | 55.88 | 26.8 | 55.6 | 31.3 | 52.1 |
| 8 | 80 | 19.83 | 49.82 | 18.6 | 49.1 | 22.4 | 17.4 |
| 9 | 90 | 14.8 | 40.36 | 14.2 | 39.7 | 16.7 | 12.4 |
| 10 | 100 | 11.58 | 34.94 | 11.45 | 33.7 | 13.4 | 9.6 |

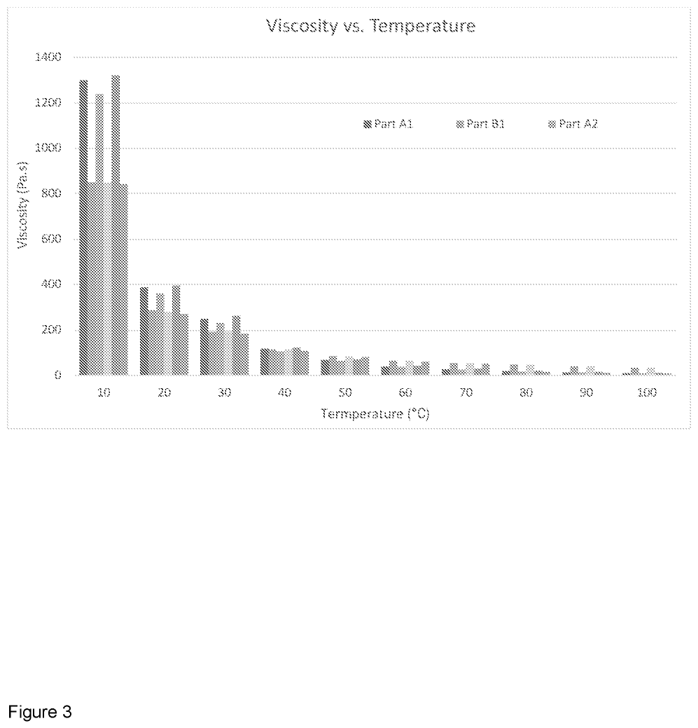

FIG. 3 of the drawings is a two-dimensional plot showing viscosity as a function of temperature.

Environment Exposure effect on Thermal conductivity (Test sample thickness 2±0.1).

TABLE 6

| | | Thermal conductivity (W/m · K.) | | | | | | | | |
|---|---|---|---|---|---|---|---|---|---|---|
| | Sample test | | Heat cycle 80° C. | | | | Humidity Cycle 80° C. with 80% Rh | | | |
| | pressure | | After 2 | After 4 | After 6 | After 8 | After 2 | After 4 | After 6 | After 8 |
| Mix | (Psi) | Initial | weeks | weeks | weeks | weeks | weeks | weeks | weeks | weeks |
| A1/B1 | 30 | 2.99 | 2.78 | 2.71 | 2.67 | 2.42 | 2.77 | 2.68 | 2.64 | 2.42 |
| | 50 | 3.01 | 2.88 | 2.84 | 2.71 | 2.46 | 2.91 | 2.87 | 2.70 | 2.52 |
| A2/B2 | 30 | 3.01 | 2.79 | 2.74 | 2.69 | 2.45 | 2.74 | 2.70 | 2.67 | 2.51 |
| | 50 | 3.06 | 2.89 | 2.78 | 2.70 | 2.43 | 2.83 | 2.89 | 2.70 | 2.57 |
| A3/B3 | 30 | 2.98 | 2.76 | 2.69 | 2.66 | 2.39 | 2.78 | 2.72 | 2.67 | 2.47 |
| | 50 | 3.09 | 2.87 | 2.83 | 2.70 | 2.44 | 2.9 | 2.88 | 2.71 | 2.56 |

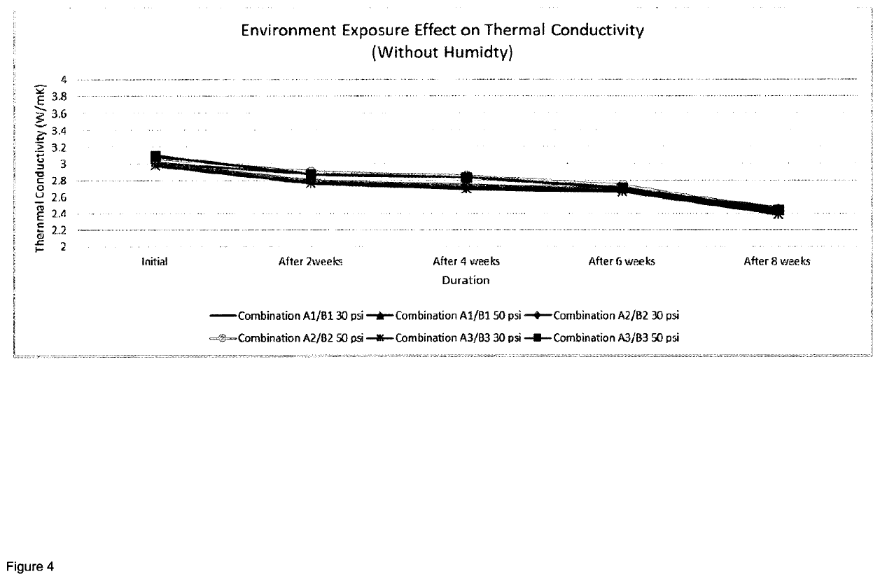

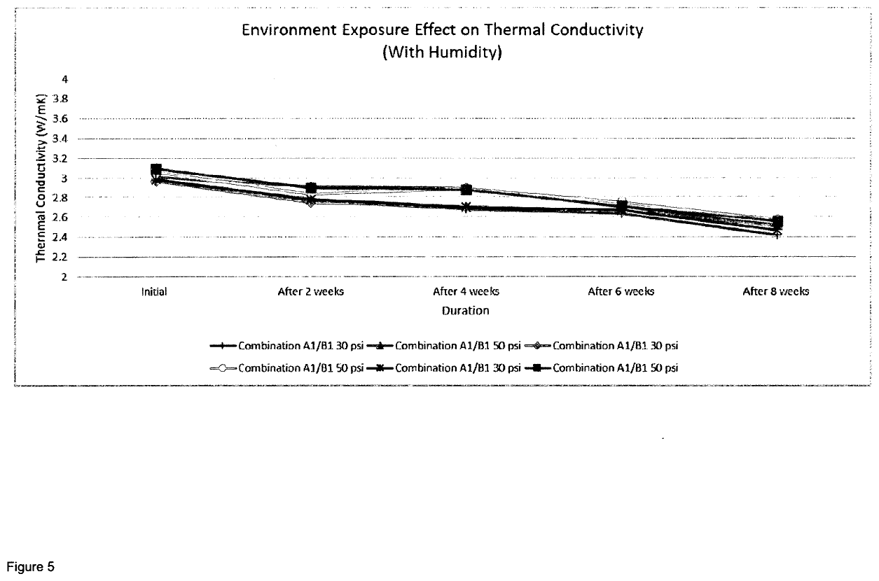

FIGS. 4 and 5 illustrate the effect of storage on thermal conductivity. The test was completed at 2, 4, 6, and 8 week intervals. The thermal conductive test was taken at two different test pressures (30 psi, 50 psi) with 2 mm thickness, 25 mm diameter sample. Thermal conductive Test temperature was in test analysis 50° C.

Combination of Exp. A1/B1 Cured adhesive sample exposed elevated temperature condition (80° C.) at different time intervals. Thermal conductive Values gradually decrease from initial results (unexposed condition).

Similarly, combination of Exp. A2/B2 and Exp. 3/B3 sample were tested at different time intervals after elevated temperature exposure (80° C.) and displayed similar results.

TABLE 7
(TEST PRESSURE (PSI) VS. THERMAL CONDUCTIVITY (W/M · K))

| | Sample | Test Pressure/Thermal Conductivity (W/m · K) | | | | | | |
|---|---|---|---|---|---|---|---|---|
| Mix | Thickness (mm) | 10 psi | 20 psi | 30 psi | 40 psi | 50 psi | 60 psi | 70 psi |
| A1/B1 | 1.0 | 2.32 | 2.39 | 2.48 | 2.57 | 2.63 | 2.68 | 2.73 |
| | 2.0 | 2.78 | 2.89 | 2.99 | 3.01 | 3.03 | 3.05 | 3.07 |
| | 3.0 | 2.89 | 2.95 | 3.02 | 3.03 | 3.1 | 3.11 | 3.15 |
| A2/B2 | 1.0 | 2.33 | 2.42 | 2.50 | 2.59 | 2.66 | 2.71 | 2.76 |
| | 2.0 | 2.8 | 2.9 | 3.02 | 3.04 | 3.06 | 3.07 | 3.1 |
| | 3.0 | 2.87 | 2.96 | 3.04 | 3.05 | 3.07 | 3.09 | 3.14 |
| A3/B3 | 1.0 | 2.32 | 2.41 | 2.49 | 2.58 | 2.65 | 2.71 | 2.76 |
| | 2.0 | 2.82 | 2.9 | 3.01 | 3.03 | 3.08 | 3.1 | 3.11 |
| | 3.0 | 2.88 | 2.98 | 3.06 | 3.07 | 3.08 | 3.11 | 3.14 |

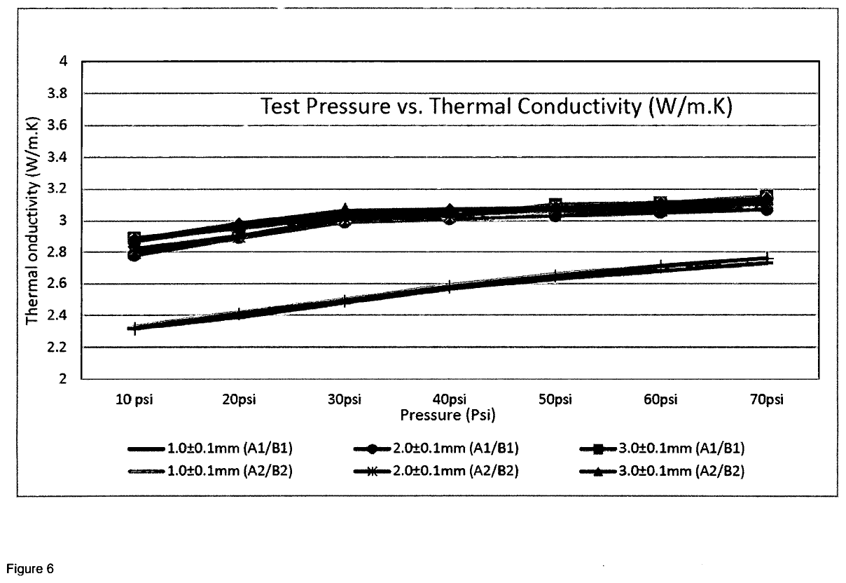

FIG. 6 of the drawings is a two-dimensional plot showing thermal conductivity as a function of pressure.

Combination of Exp. A1/B1 cured sample thermal conductivity was tested at different test pressure (10, 20, 30, 40, 50, 60, 70 psi) and different sample thickness (1 mm, 2 mm, 3 mm) and test samples diameter is 25 mm. At high thickness (2 mm, 3 mm) and high-test pressure (50 psi to 70 psi), thermal conductivity results increases gradually.

Combination of Exp. A2/B2 cured sample thermal conductivity was tested at different test pressure (10, 20, 30, 40, 50, 60, 70 psi) and different sample thickness (1 mm, 2 mm, 3 mm) and test samples diameter is 25 mm. At high thickness (2 mm, 3 mm) and high-test pressure (50 psi to 70 psi), Thermal conductivity results increase gradually.

Combination of Exp. A3/B3 cured sample thermal conductivity was tested at different test pressure (10, 20, 30, 40, 50, 60, 70 psi) and different sample thickness (1 mm, 2 mm, 3 mm) and test samples diameter is 25 mm. At high thickness (2 mm, 3 mm) and high-test pressure (50 psi to 70 psi) Thermal conductivity results increase gradually. Test temperature was in test analysis 50° C.

TABLE 8
(TEMPERATURE VS THERMAL CONDUCTIVITY)

| | Test Temperature/Thermal Conductivity (W/m · K) | | | | | | | |
|---|---|---|---|---|---|---|---|---|
| Mix | 25° C. | 40° C. | 50° C. | 60° C. | 70° C. | 80° C. | 90° C. | 100° C. |
| A1/B1 | 2.95 | 2.94 | 3.10 | 3.05 | 3.04 | 3.12 | 2.93 | 2.95 |
| A2/B2 | 2.99 | 3.02 | 3.07 | 3.04 | 3.04 | 3.10 | 2.95 | 2.98 |
| A3/B3 | 2.89 | 2.98 | 3.08 | 3.04 | 3.04 | 3.10 | 2.92 | 2.90 |

(Test Sample thickness 3.0±0.1 mm, Test sample diameter 25 mm and Test pressure 50 psi)

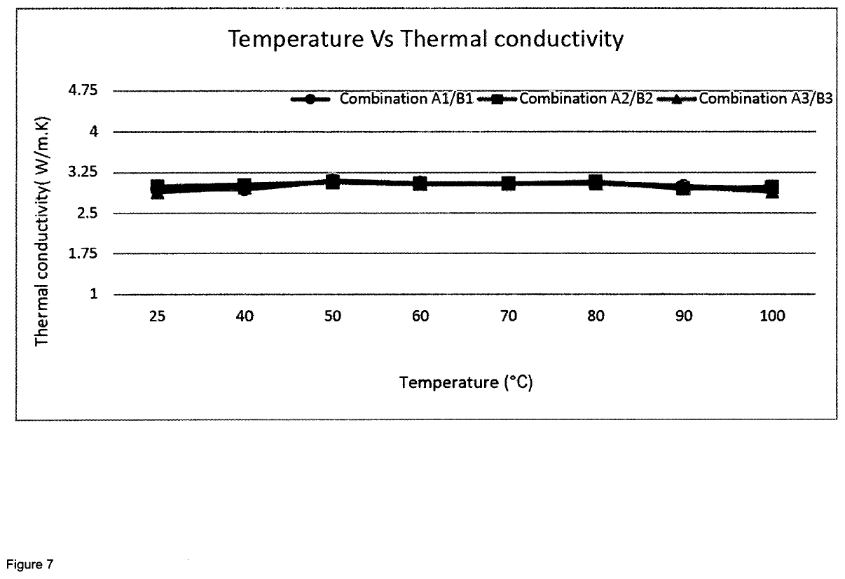

FIG. 7 of the drawings is a two-dimensional plot showing thermal conductivity as a function of temperature.

Cured material tested at constant sample thickness 3 mm, constant test pressure 50 psi and different test temperatures for Thermal conductivity, test temperature (25-100° C.) did not affect thermal conductivity value stays almost same.

TABLE 9
(TEMPERATURE VS GEL TIME)

| | | Gel Time (Minutes) | | |
|---|---|---|---|---|
| S. No | Temperature (° C.) | Mix A1/B1 | Mix A2/B2 | Mix A3/B3 |
| 1 | 18 | 67 | 135 | 29 |
| 2 | 25 | 25 | 78 | 10 |
| 3 | 35 | 15 | 59 | 7 |
| 4 | 50 | 9 | 33 | 5 |

Gel time/pot life/workability time terms are used to describe thickening of a two-part adhesive after mixed together.

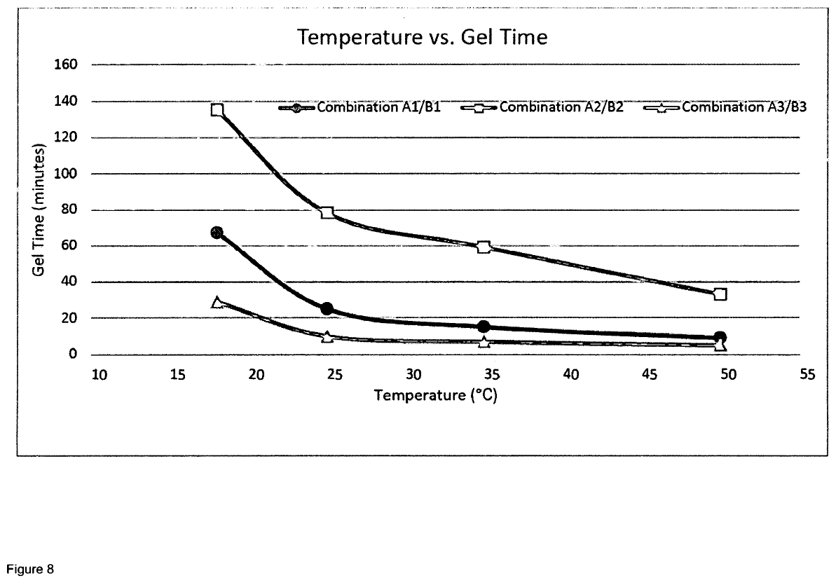

As per testing results gel times are affected by the temperature (See FIG. 8).

Gel time for two-component material mainly depends on catalyst amount used in experiments and Acid number of maleinized functional polybutadiene and Hydroxyl number of Hydroxyl terminated butadiene and also ratio of maleinized functional polybutadiene and hydroxyl terminated butadiene.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A two-part curable composition which cures to form a thermally conductive cured product, comprising:
a first-part comprising: (1) a maleic anhydride adducted polybutadiene component; (2) a non-reactive diluent component; (3) a wetting agent component; and (4) a filler component; and
a second-part comprising: (1) a hydroxyl terminated polybutadiene component; (2) a catalytic component for catalyzing the cure reaction; (3) a diluent component; (4) a filler component; and (5) a wetting agent component, wherein at least one of the filler components of the first-part and the second-part comprises a thermally conductive filler.

2. The two-part curable composition according to claim 1, wherein the weight ratio of the first-part to the second-part is approximately 1:1 by weight.

3. The two-part curable composition according to claim 1, wherein the composition cures in less than approximately 60 minutes from the time the first-part and the second-part are brought together at room temperature.

4. The two-part curable composition according to claim 1, wherein the composition cures in less than approximately 10 minutes from the time the first-part and the second-part are brought together at room temperature.

5. The two-part curable composition according to claim 1, which cures to form a cured product with a thermal conductivity ranging from approximately 2.0 to approximately 5.0 watts per meter-kelvin.

6. The two-part curable composition according to claim 1, which cures to form a cured product with a thermal conductivity ranging from approximately 2.0 to approximately 3.0 watts per meter-kelvin.

7. The two-part curable composition according to claim 1, wherein the maleic anhydride adducted polybutadiene component of the first-part is present from approximately 10 percent to approximately 20 percent by weight of the total weight of the first-part.

8. The two-part curable composition according to claim 1, wherein the hydroxyl terminated polybutadiene component of the second-part is present from approximately 10 percent to approximately 20 percent by weight of the total weight of the second-part.

9. The two-part curable composition according to claim 1, wherein the thermally conductive filler is present from approximately 40 percent to approximately 80 percent by weight of the total weight of the first-part, the second-part and/or the first- and second-parts.

10. The two-part curable composition according to claim 1, wherein the wetting agent component of the first-part is present from approximately 0.1 percent to approximately 5.0 percent by weight of the total weight of the first-part.

11. The two-part curable composition according to claim 1, wherein the non-reactive diluent component of the first-part is present from approximately 5 percent to approximately 20 percent by weight of the total weight of the first-part and the second-part.

12. The two-part curable composition according to claim 11, wherein the non-reactive diluent component of the first-part comprises at least one of an isopropylated triphenyl phosphate, a butylated triphenyl phosphate, an isopropylated triaryl phosphate, a tris-chloropropyl phosphate, and combinations or mixtures thereof.

13. The two-part curable composition according to claim 1, wherein the catalytic component of the second-part is present from approximately 0.1 to approximately 5 per hundred resin by weight of the total weight of the second-part.

14. The two-part curable composition according to claim 1, wherein the first-part and second-part comprise a pre-cured viscosity of approximately 200 to approximately 500 pascal-second.

15. The two-part curable composition according to claim 1, wherein the average particle size of the thermally conductive filler ranges from approximately 10 to approximately 500 micrometers.

16. The two-part curable composition according to claim 1, further comprising a curable resin and a filler, wherein the filler comprises thermally conductive, smooth, spherical particles having an average diameter of less than approximately 500 microns.

17. The two-part curable composition according to claim 1, wherein the thermally conductive filler comprises at least one an inorganic filler, a boron nitride, an aluminum oxide, an aluminum nitride, graphite, a silicon carbide, a carbon nanotube, a graphene nanoplatelet, and combinations or mixtures thereof.

18. A thermally conductive cured product formed using the two-part curable composition according to claim 1.

19. A two-part curable composition which cures to form a thermally conductive cured product, comprising:
a first-part comprising: (1) at least one maleinized polybutadiene component; (2) a non-reactive diluent component; (3) one or more wetting agent components and; (4) a filler component; and
a second part comprising: (1) at least one hydroxyl terminated polybutadiene or hydroxyl terminated polybutadiene, polyester polyol, polyether polyol, component; (2) a catalytic component for catalyzing the cure reaction; (3) a diluent component; and (4) a filler component, for the bonding of a heat generating component to a substrate, wherein at least one part of the composition has a filler component that comprises a thermally conductive filler.

20. A thermally conductive cured product formed using the two-part curable composition according to claim 19.
